(19) United States
(12) Patent Application Publication
(10) Pub. No.: US 2012/0242806 A1
(43) Pub. Date: Sep. 27, 2012

(54) DYNAMIC STEREO CAMERA CALIBRATION SYSTEM AND METHOD

(75) Inventors: Faroog IBRAHIM, Dearborn Heights, MI (US); Shi SHEN, Farmington Hills, MI (US)

(73) Assignee: TK Holdings Inc.

(21) Appl. No.: 13/427,781

(22) Filed: Mar. 22, 2012

Related U.S. Application Data
(60) Provisional application No. 61/466,864, filed on Mar. 23, 2011.

(51) Int. Cl. H04N 7/18; H04N 13/02

(52) U.S. Cl. 348/47; 348/46; 348/E13.074; 348/E07.085

(57) ABSTRACT

A dynamic calibration system includes a rectification module that receives raw stereo image data from a vehicle stereo image system, rectifies the raw stereo image data, and outputs rectified stereo image data as a result thereof. A stereo matching module performs stereo matching processing on the rectified stereo image data, to thereby obtain a range map. A unit object generator receives the range map, detects at least one object in the range map, and provides information to the rectification module for use in determining whether a row shift operation should be performed in rectifying the raw stereo image data by the rectification module. A tracker receives information regarding the at least one objected detected by the unit object generator, and provides information to the rectification module for use in determining whether a column shift operation should be performed in rectifying the raw stereo image data by the rectification module.

### BACKGROUND

1. Field of the Invention

The present application generally relates to a dynamic stereo camera calibration system and method used in driver assistance systems for a vehicle. More specifically, the present application relates to calibration methods for a stereo vision system of a vehicle.

2. Background of the Invention

Driver assistance systems for vehicles are gaining in popularity, as they result in lesser number of vehicular accidents and resulting injuries to vehicular passengers. One such driver assistance system is a vehicular stereo vision system, which provides for enhanced field of vision for a driver of a vehicle.

During operation of a vehicle over time, the vehicular stereo vision system may deteriorate due to several factors, such as having vehicle cameras and sensors not pointing in proper directions, which can lead to sparseness and inaccuracy in vehicle stereo image data provided to a vision processing device. As such, there is a need to calibrate the vehicular stereo vision system from time to time, to increase the density and accuracy and to provide better stereo image data for analysis by a vision processing system.

### SUMMARY OF THE INVENTION

According to one exemplary embodiment, a dynamic calibration system includes a rectification module that receives raw stereo image data from a vehicle stereo image system, rectifies the raw stereo image data, and outputs rectified stereo image data as a result thereof. A stereo matching module performs stereo matching processing on the rectified stereo image data, to thereby obtain a range map. A unit object generator receives the range map, detects at least one object in the range map, and provides information to the rectification module for use in determining whether a row shift operation should be performed in rectifying the raw stereo image data by the rectification module. A tracker receives information regarding the at least one object detected by the unit object generator, and provides information to the rectification module for use in determining whether a column shift operation should be performed in rectifying the raw stereo image data by the rectification module.

According to another exemplary embodiment, a dynamic calibration method includes receiving raw stereo image data from a vehicle stereo vision system, rectifying the raw stereo image data, and outputting rectified stereo image data; performing stereo matching processing on the rectified stereo image data, to thereby obtain a range map; detecting at least one object in the range map, and providing information for use in determining whether a row shift operation should be performed in rectifying the raw stereo image data by the rectification step; and receiving information regarding the at least one object detected, and providing information for use in determining whether a column shift operation should be performed in rectifying the raw stereo image data by the rectification step, wherein the dynamic calibration method performs calibration on image data while the vehicle stereo vision system is operational and outputting image data to a vehicle safety system.

According to another exemplary embodiment, a non-transitory computer readable medium stores computer program product, which, when executed by a computer, causes the computer to perform the functions of: receiving raw stereo image data from a vehicle stereo vision system, rectifying the raw stereo image data, and outputting rectified stereo image data; performing stereo matching processing on the rectified stereo image data, to thereby obtain a range map; detecting at least one object in the range map, and providing information for use in determining whether a row shift operation should be performed in rectifying the raw stereo image data by the rectification step; and receiving information regarding the at least one object detected, and providing information for use in determining whether a column shift operation should be performed in rectifying the raw stereo image data by the rectification step, wherein the dynamic calibration method performs calibration on image data while the vehicle stereo vision system is operational and outputting image data to a vehicle safety system.

### BRIEF DESCRIPTION OF THE DRAWINGS

These and other features, aspects, and advantages of the present invention will become apparent from the following description and accompanying exemplary embodiments shown in the drawings, which are briefly described below.

FIG. 1 is a block diagram of a stereo vision calibration system, according to an exemplary embodiment.

FIG. 2 is a flow diagram of a stereo vision calibration method, according to an exemplary embodiment.

FIG. 3 illustrates a process for fixing row shift problems, according to an exemplary embodiment.

FIGS. 4-5 illustrate in diagrammatic form geometrical relationships of vehicles for fixing column shift problems, according to an exemplary embodiment.

### DETAILED DESCRIPTION

According to various exemplary embodiments, a driver assistance system includes a digital map system, an on-board stereo vision system, and a global positioning system (GPS). Data from each system may be used to provide cost effective or “eco-friendly” path planning for automotive vehicles. A stereo vision system for a vehicle includes multiple image sensors or cameras. Some calibration methods for the image sensors used for stereo vision are mostly offline, e.g., calibration methods are used before the stereo vision system is operational. Some calibration methods may include defects. For example, the methods may result in measurement errors. As another example, the lens distortion of the image sensors may not be well modeled. As yet another example, due to vibration and thermal effects, camera installation parameters may change as a result of driving. The lens position may change and thus the relative position between the two lenses of the system may change as well. These changes may degrade the performance of the stereo vision system.

Referring generally to the figures, an online calibration system and method for a stereo vision system is described. The stereo vision system includes image sensors (e.g., a left image and a right image). After offline (static) calibration of the image sensors is done, drifting in the calibration may occur during vehicle operation, which results in row shifts and/or column shifts between the left and right images in the stereo vision system. Both row shifts and column shifts degrade the stereo matching algorithm performance. Row shifts between the left and right images result in lesser fill in the calculated stereo range map. Column shifts between the left and right images result in range measurement errors.

By using the online calibration method of the present disclosure, the information from the stereo vision systems is more accurate and improves system performance. It also decreases the frequency of doing offline calibration at, for example, a dealership and in the development phase. Further, the calibration may be used as a standalone online calibration.

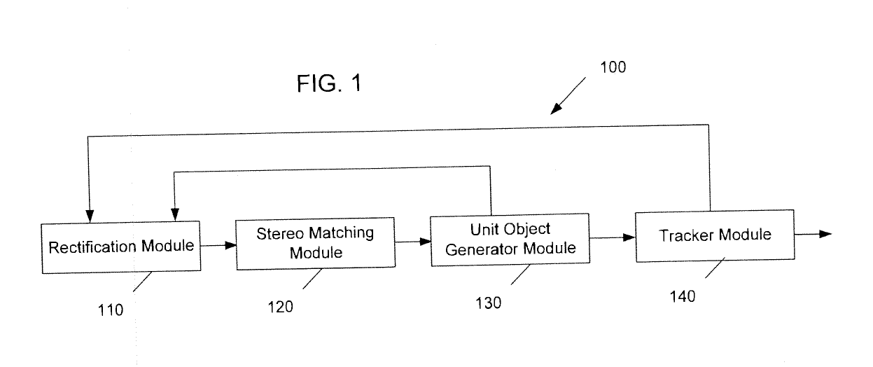

Referring to FIG. 1, a block diagram of a stereo vision calibration system 100 is shown, according to an exemplary embodiment. The system 100 includes a rectification module 110 for projecting two or more images received from image sensors or cameras onto a common image plane. The rectification module 110 receives raw stereo images from a vehicle vision system (not shown), and outputs rectified stereo images. The system 100 further includes a stereo matching module 120 that receives the rectified stereo images and that utilizes stereo matching algorithms on the rectified stereo images to thereby output a range map. The system further includes a unit object generator module 130 that receives the range map output by the stereo matching module 120, and that outputs an object list based on objects detected by the unit object generator 130. The system also includes a tracker module 140 that receives the object list output by the unit object generator module 130 and that determines whether a column shift of image pixel data is required. The unit object generator module 130 and the tracker module 140 provide information to the rectification module 110 for use in projecting the images onto a common image plane. In more detail, the tracker module 140 tracks detected objects based on the information output by the unit object generator module 130.

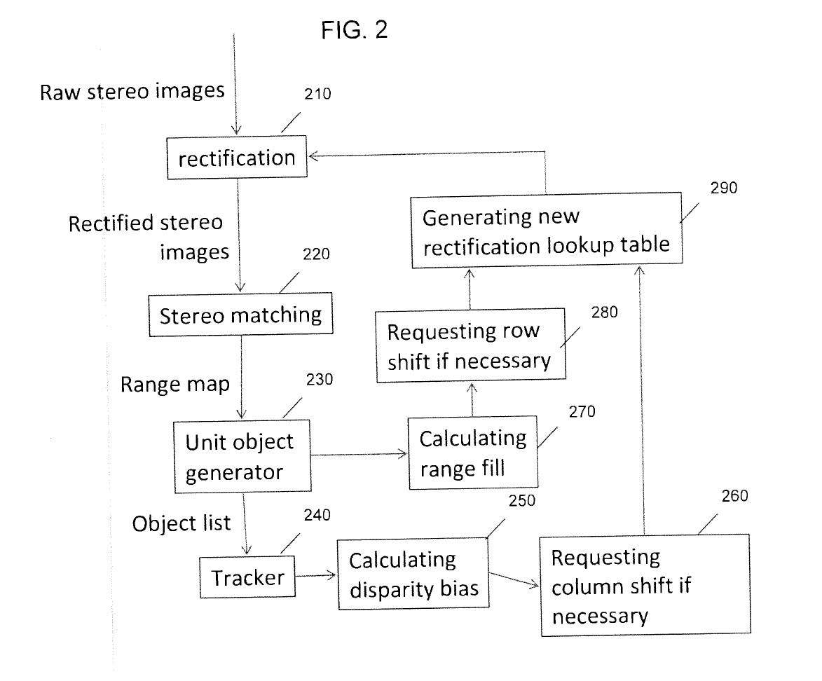

FIG. 2 is a flow diagram of processings performed by the stereo vision calibration system 100 of FIG. 1. A rectification stage 210 receives two or more images (stereo images received as raw stereo image data) received from image sensors or cameras, and rectifies those images onto a common image plane, as rectified stereo images. A stereo matching stage 220 receives the rectified stereo images and utilizes stereo matching algorithms on the rectified stereo images to thereby output a range map. A unit object generator stage 230 receives the range map output by the stereo matching stage 220, detects objects in the range map, and outputs an object list corresponding to the objects detected. A tracker stage 240 receives the object list output by the unit object generator stage 230, and determines whether or not shifting of image pixel data is required. In more detail, a disparity bias stage 250 computes a disparity bias of the objects in the object list, and based on the calculated disparity bias, in a stage 260 it is determined whether or not a column shift request needs to be made. The unit object generator stage 230 also calculates a range fill in stage 270, and based on the range fill, in a stage 280 it is determined whether or not a row shift request needs to be made. If either or both a row shift request and a column shift request is made, a new rectification lookup table is generated in stage 290, which is used by the rectification stage 210 on future raw stereo images to be input to the rectification stage 210.

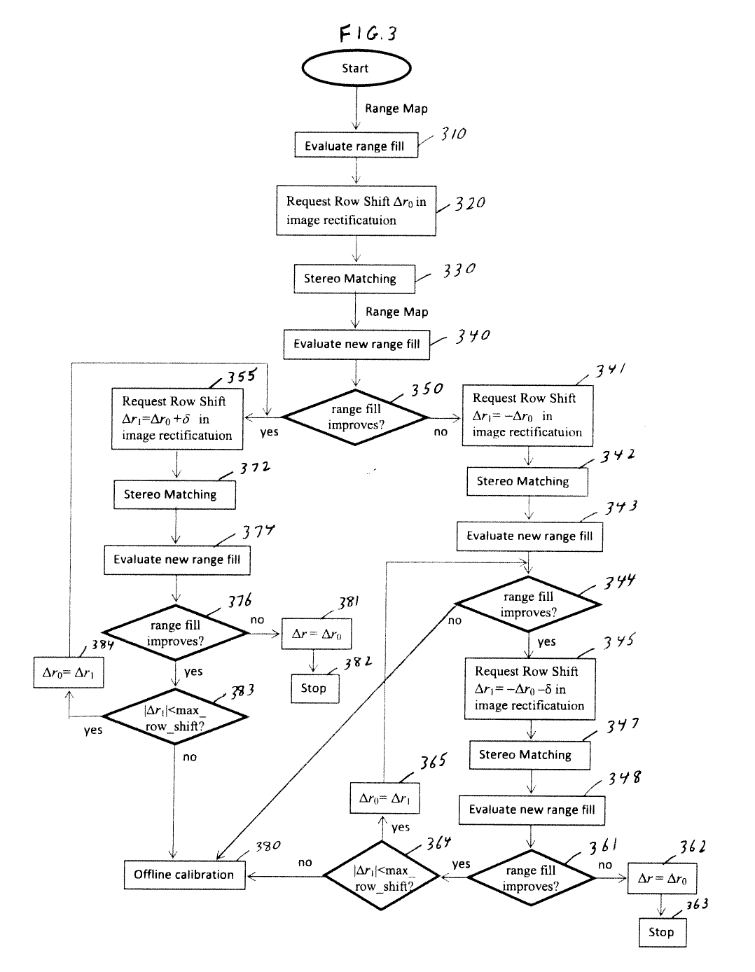

Referring to FIG. 3, a method for online calibration to fix row shift problems is shown, according to an exemplary embodiment. The method of FIG. 3 is used to fix a range fill problem of the stereo vision system in the event of a row shift. The method includes a step 310 of evaluating the density in the range fill of a range map, such as by measuring unit objects or segment statistics over a period of time. For example, the number of objects and the distribution of the objects in an image may be evaluated.

The method further includes a step 320 of requesting a row shift Δr₀ in image rectification. The method includes a step 330 of executing the row shift operation and performing stereo matching of the row shifted image data, thereby obtaining a range map. The method further includes a step 340 of evaluating a new range fill.

In a step 350, a determination is made as to whether or not the range fill results in improvement of the image data. If the range fill did not result in improvement as determined in step 350, the method includes requesting a new row shift Δr₁=−Δr₀ in step 341. The row shift is executed and stereo matching is performed in step 342, and a new range fill is evaluated in step 343. In step 344, a determination is made as to whether or not the range fill results in improvement of the image data. If the determination in step 344 is Yes (there is improvement), then in step 345, a new row shift is requested in image rectification: Δr₁=−Δr₀−δ in step 346, and the row shift operation is executed in rectifying the image data, and stereo matching is performed in step 347. In step 348, a new range fill is evaluated. In step 361, a determination is made as to whether or not the range fill results in improvement of the image data. If No, then Δr=Δr₀ is set in step 362, and the process stops in step 363. If the determination in step 361 is Yes (there is improvement), then a determination is made in step 364 as to whether |r₁|<max_row_shift. If Yes, then Δr₀=Δr₁ is set in step 365, and the process returns to step 344. If the determination in step 364 is No (there is no improvement), then offline calibration is requested in step 380.

If the range fill did result in improvement as determined in step 350, a new row shift is requested in image rectification: Δr₁=Δr₀+δ in step 355. In step 372, the row shift is executed for the image data, and stereo matching is performed on the row-shifted image data. In step 374, a new range fill is evaluated. In step 376, a determination is made as to whether the range fill results in improvement. If No, then Δr=Δr₀ is set in step 381, and the process stops in step 382. If Yes, then a determination is made in step 383 as to whether |Δr₁|<max_row_shift. If Yes, Δr₀=Δr₁ is set in step 384, and the process returns to step 355. If No, offline calibration is requested in step 380.

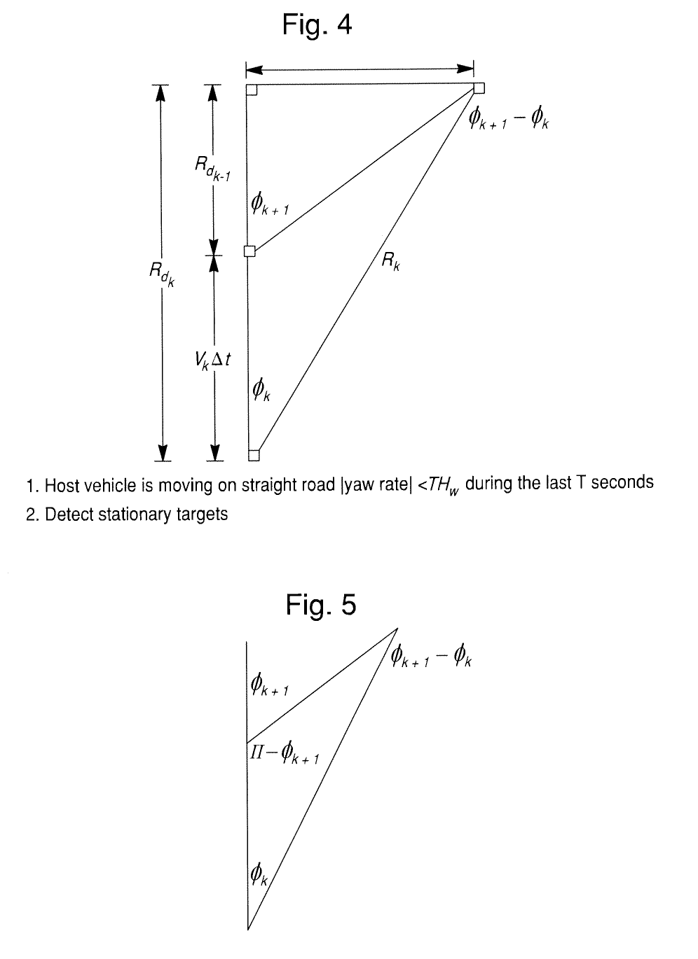

Referring now to FIGS. 4 and 5, methods for online calibration to fix column shift problems are shown, according to an exemplary embodiment. The first method is used when the host vehicle is moving on a straight road with a yaw rate of: |yawrate<TH_{w}| during the last T seconds. The method further include detecting stationary targets.

The first method then includes one of two sub-methods. One such method (method A) includes checking R_{d}_{ₖ} tan φₖ≈R_{d}_{ₖ₊₁} tan φₖ₊₁ and checking φₖ₊₁≧φₖ+TH_{φ},TH_{φ} being a function of the host vehicle speed and Rₖ. A second such method (method B) includes calculating the histogram of the target's speed in areas where the location of the stationary target is highly possible. Since stationary targets are the most frequent targets, the speed histogram provides information about the stationary object.

Referring to FIG. 5, the following equation holds:

$$\frac{{V}_{h} Δ t}{sin ( {φ}_{k + 1} \sim {φ}_{k} )} = \frac{{R}_{k}}{sin ( {φ}_{k + 1} )} = \frac{{R}_{k + 1}}{sin ( {φ}_{k} )}$$

$$Therefore , ⇒ {R}_{k} \frac{{V}_{h} Δ t}{sin ( {φ}_{k + 1} - {φ}_{k} )} * sin ( {φ}_{k + 1} )$$

Comparing Rₖ with the measured Rₖ provides the error in the measured Rₖ: E_{R}_{ₘ}=Rₖ−Rₖ_{ₘ}.

A second method of fixing column shift problems includes calculating the histogram of the target's speed in areas where the location of the stationary target is highly possible. Referring to FIG. 4, the method further includes calculating Rₘ+VₕVₜᵢ+Vₜₕ, and passing the value through a high pass filter with a high time constant. The high pass filter filters (DC) component of Rₘ+VₕVₜᵢ+Vₜₕ. The constant component that is removed is the error in the relative velocity of the stationary target. Therefore, as a result, the following holds:

\dot{R}ₙ=\dot{R}_{T}+K\dot{R}_{T} [symbol] R_{T}+B, where B is equal to the difference between HPF input and HPF output.

$$K = \frac{B}{{\dot{R}}_{T}}$$

The present disclosure has been described with reference to example embodiments, however persons skilled in the art will recognize that changes may be made in form and detail without departing from the spirit and scope of the disclosed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the exemplary embodiments is manifestly intended to be as broad as possible. For example, unless specifically otherwise noted, the exemplary embodiments reciting a single particular element also encompass a plurality of such particular elements.

Exemplary embodiments may include program products comprising computer or machine-readable media for carrying or having machine-executable instructions or data structures stored thereon. For example, the driver monitoring system may be computer driven. Exemplary embodiments illustrated in the methods of the figures may be controlled by program products comprising computer or machine-readable media for carrying or having machine-executable instructions or data structures stored thereon. Such computer or machine-readable media can be any available media which can be accessed by a general purpose or special purpose computer or other machine with a processor. By way of example, such computer or machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of computer or machine-readable media. Computer or machine-executable instructions comprise, for example, instructions and data which cause a general purpose computer, special purpose computer, or special purpose processing machines to perform a certain function or group of functions. Software implementations of the present invention could be accomplished with standard programming techniques with rule based logic and other logic to accomplish the various connection steps, processing steps, comparison steps and decision steps.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

1. A dynamic calibration system, comprising:
a rectification module configured to receive raw stereo image data from a vehicle stereo image system, to rectify the raw stereo image data, and to output rectified stereo image data as a result thereof;
a stereo matching module configured to perform stereo matching processing on the rectified stereo image data, to thereby obtain a range map;
a unit object generator configured to receive the range map output from the stereo matching module, to detect at least one object in the range map, and to provide information to the rectification module for use in determining whether a row shift operation should be performed in rectifying the raw stereo image data by the rectification module; and
a tracker configured to receive information regarding the at least one object detected by the unit object generator, and to provide information to the rectification module for use in determining whether a column shift operation should be performed in rectifying the raw stereo image data by the rectification module,
wherein the dynamic calibration system performs calibration on image data while the vehicle stereo vision system is operational and outputting image data to a vehicle safety system.

2. The dynamic calibration system according to claim 1, wherein the vehicle stereo vision system comprises:
a plurality of image sensors provided on different locations on an exterior or interior of the vehicle; and
a plurality of cameras provided on different locations on an exterior or interior of the vehicle.

3. The dynamic calibration system according to claim 1, wherein the at least one calibration algorithm includes performing row shifting corrections on pixels of the two or more images received from the vehicle stereo vision system, to thereby perform a range fill check so that range map density and accuracy are improved.

4. The dynamic calibration system according to claim 3, wherein the tracker is configured to track detected objects based on the information output by the unit object generator.

5. The dynamic calibration system according to claim 3, wherein the unit object generator evaluates an efficacy of the range fill check by evaluating pixel density of a range map region of the stereo image data by measuring unit objects or segment statistics over a period of time.

6. The dynamic calibration system according to claim 3, wherein, in a case where the unit object generator has determined that the range fill check has improved the stereo image data to be analyzed by a vision processing system, the unit object generator instructs the rectification module to perform at least one additional row shifting correction on pixels of the two or more images received from the vehicle stereo vision system.

7. The dynamic calibration system according to claim 6, wherein, in a case where the unit object generator has determined that the at least one additional row shifting correction performed on the stereo image data has not improved the pixel density of the range map region of the stereo image data to be analyzed by a vision processing system, the unit object generator outputs a request that an off-line calibration be performed on the vehicle stereo vision system.

8. The dynamic calibration system according to claim 1, wherein the at least one calibration method includes performing a column shifting correction on pixels of the two or more images received from the vehicle stereo vision system, to thereby perform a range fill check so that range map density and accuracy are improved.

9. The dynamic calibration system according to claim 8, wherein the column shifting correction includes calculating a histogram of a speed of the vehicle in a locations where a stationary target has been determined to be highly possible, to thereby obtain histogram data.

10. The dynamic calibration system according to claim 9, further comprising a high-pass filter,
wherein the column shifting correction is performed by passing the histogram data through the high-pass filter to remove all but a constant speed component from the histogram data, to improve range accuracy of the stereo image data.

11. The dynamic calibration system according to claim 10, wherein the constant speed component corresponds to an error in a relative velocity of the stationary target, to be corrected by performing the column shifting correction.

12. A dynamic calibration method, comprising:
receiving raw stereo image data from a vehicle stereo vision system, rectifying the raw stereo image data, and outputting rectified stereo image data;
performing stereo matching processing on the rectified stereo image data, to thereby obtain a range map;
detecting at least one object in the range map, and providing information for use in determining whether a row shift operation should be performed in rectifying the raw stereo image data by the rectification step; and
receiving information regarding the at least one object detected, and providing information for use in determining whether a column shift operation should be performed in rectifying the raw stereo image data by the rectification step
wherein the dynamic calibration method performs calibration on image data while the vehicle stereo vision system is operational and outputting image data to a vehicle safety system.

13. The dynamic calibration method according to claim 12, wherein the vehicle stereo vision system comprises:
a plurality of image sensors provided on different locations on an exterior or interior of the vehicle; and
a plurality of cameras provided on different locations on an exterior or interior of the vehicle.

14. The dynamic calibration method according to claim 12, wherein the at least one calibration process performed includes performing row shifting corrections on pixels of the two or more images received from the vehicle stereo vision system, to thereby perform a range fill check so that range map density and accuracy are improved.

15. The dynamic calibration method according to claim 14, further comprising:
tracking success of calibration processes performed based on the information output in the receiving step.

16. The dynamic calibration method according to claim 15, wherein the tracking comprises:
evaluating an efficacy of the range fill check by evaluating pixel density of a range map region of the stereo image data by measuring unit objects or segment statistics over a period of time.

17. The dynamic calibration method according to claim 15, wherein, in a case where the tracking step has determined that the range fill check has improved the stereo image data to be analyzed by a vision processing system, the method further comprising:
performing at least one additional row shifting correction on pixels of the two or more images received from the vehicle stereo vision system.

18. The dynamic calibration method according to claim 17, wherein, in a case where the tracking step has determined that the at least one additional row shifting correction performed on the stereo image data has not improved the pixel density of the range map region of the stereo image data to be analyzed by a vision processing system, the method comprising:
outputting a request that an off-line calibration be performed on the vehicle stereo vision system.

19. The dynamic calibration method according to claim 12, wherein the at least one calibration process performed includes performing a column shifting correction on pixels of the two or more images received from the vehicle stereo vision system, to thereby perform a range fill check so that range map density and accuracy are improved.

20. The dynamic calibration method according to claim 19, wherein the column shifting correction comprises:
calculating a histogram of a speed of the vehicle in a locations where a stationary target has been determined to be highly possible, to thereby obtain histogram data.

21. The dynamic calibration method according to claim 20, wherein the column shifting correction comprises:
passing the histogram data through a high-pass filter to remove all but a constant speed component from the histogram data, to improve range accuracy of the stereo image data.

22. The dynamic calibration method according to claim 21, wherein the constant speed component corresponds to an error in a relative velocity of the stationary target, to be corrected by performing the column shifting correction.
